(19) United States
(12) Patent Application Publication
(10) Pub. No.: US 2014/0173986 A1
(43) Pub. Date: Jun. 26, 2014

(54) APRARATUS FOR OPERATING A DOOR OR HATCH ON A VEHICLE

(71) Applicants: Peter Van Gastel, Sollingen (DE); Iko Lindic, Essen (DE)

(72) Inventors: Peter Van Gastel, Sollingen (DE); Iko Lindic, Essen (DE)

(21) Appl. No.: 14/237,123

(22) PCT Filed: Aug. 17, 2011
(86) PCT No.: PCT/DE2011/075195

§ 371 Date: Feb. 4, 2014

(30) Foreign Application Priority Data
Aug. 17, 2011 (WO) DE2011/075195

(51) Int. Cl. E05F 15/20; H01B 11/18

(52) U.S. Cl. CPC E05F 15/2046; E05F 15/2023; H01B 11/1834
USPC 49/31

(57) ABSTRACT

Apparatus for operating a door or hatch on a vehicle, wherein the apparatus has a sensor unit in order to allow detection of an object in at least one detection area which joins the motor vehicle, with the result that the detection can he used to activate the operation of the moving portion, wherein the sensor unit is in the form of a coaxial cable, wherein a conductor of the coaxial cable which is in the form of a metal, core is used as an active screen.

The invention relates to an apparatus for operating a door or hatch of a vehicle, wherein the apparatus has a sensor unit in order to allow detection of an object in at least one detection area which borders the motor vehicle, with the result that the operation of the moving part can be activated, using the detection.

The prior art discloses a sensor unit which is arranged on a bumper. The sensor unit is a single-wire electrode which, as a core, has a copper wire which is sheathed by a plastic layer. However, one disadvantage of a sensor unit of this kind is the low range for registering that the user is approaching the tailgate.

The sensor detects the user only when he is just in front of the bumper, with the result that the tailgate opens only very late in the case of a keyless locking system.

The object of the invention is therefore to provide an apparatus for operating a door or hatch of a vehicle with a sensor unit which has a greater range for detecting the user.

The invention is achieved in that the sensor unit is in the form of a coaxial cable, wherein a conductor of the coaxial cable, which conductor is in the form of a metallic core, serves as an active shield.

The solution according to the invention provides the advantage that the range of the sensor unit for detecting that the user is approaching the tailgate is increased. As a result, the communication between a vehicle controller and a radio key in the possession of the user is already started at an early point in time, with the result that the tailgate is already opened as the user approaches said tailgate.

According to a further preferred embodiment of the invention, provision is made for the conductor of the coaxial cable to be at least partially Sheathed by a first insulation layer of the coaxial cable.

According to a further preferred embodiment of the invention, provision is made for the first insulation layer of the coaxial cable to have a εᵣ which has a value of between 5 and 1. The advantage is that the range of the sensor unit is increased as a result because the electrical field generates larger detection area.

According to a further preferred embodiment of the invention, provision is made for the first insulation layer to be composed of a foamed material which has air chambers.

According to a further preferred embodiment of the invention, provision is made for the first insulation layer to be composed of air.

According to a further preferred embodiment of the invention, provision is made for the first insulation layer to be at least partially sheathed by a metallic layer which serves as a sensor electrode.

According to a further preferred embodiment of the invention, provision is made for the metallic layer to be in the form of a metal foil and/or a wire mesh and/or a wire, in particular it the form of a helically wound wire.

According to a further preferred embodiment of the invention, provision is made for the metallic layer to be at least partially sheathed by a second insulation layer, in particular an insulation layer which is composed of plastic and which serves to provide insulation against external environmental influences, in particular in order to protect the metallic components of the coaxial cable against moisture and corrosion.

According to a further preferred embodiment of the invention, provision is made for the core to be in the form of a copper wire.

According to a further preferred embodiment of the invention, provision is made for the sensor device to be arranged on a bumper.

According to a further preferred embodiment of the invention, provision is made for the coaxial cable which is in the form of a sensor unit to be formed in a water-tight manner at at least one end. This advantageously prevents moisture from entering the individual layers of the sensor unit and prevents the electrical field which is generated by the sensor unit from being disturbed.

The invention is schematically illustrated with reference to an exemplary embodiment in the figures, in which:

FIG. 1 shows a vehicle comprising a sensor unit which is arranged in a bumper

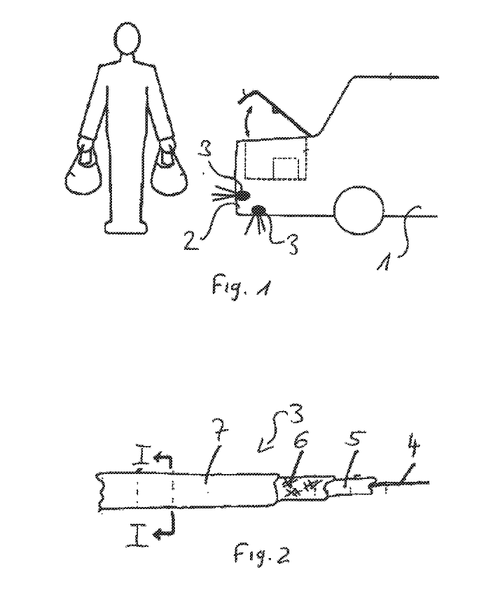

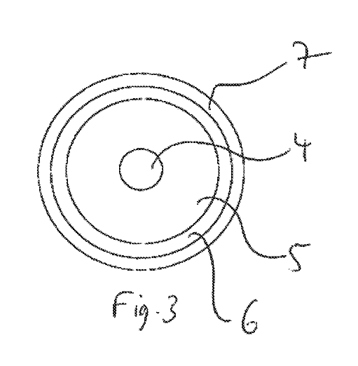

FIG. 2 shows a side view of the sensor unit which is in the form of a coaxial cable and has a layer structure

FIG. 3 shows a section I-I through the coaxial cable in FIG. 2.

FIG. 1 shows a vehicle 1 which has a bumper 2 in which two sensor units 3 are arranged, wherein one sensor unit is oriented toward the ground and the other is oriented in a manner offset through substantially 90° with respect to the ground.

The user approaches a tailgate of the vehicle. The sensor unit 3 detects the user in a bordering detection area with the aid of the electrical field which is generated by the sensor unit 3, with the result that the operation of the tailgate can be activated using the detection.

As shown in FIGS. 2 and 3, the sensor unit is in the form of a coaxial cable which has a layer structure. The sensor unit 3 is in the form of a coaxial cable, wherein the conductor 4 of the coaxial cable, which conductor is in the form of a metallic core, serves as an active shield. In this case, the metallic core of the coaxial cable has the same potential as the first metallic sheath. The metallic sheath forms the sensor electrode. As a result, the first metallic sheath does not act as a sensor electrode in the inward direction, but rather intensifies in the outward direction, that is to say a field amplification in the outward direction is achieved. The conductor 4 is formed from a copper wire. The conductor 4 of the coaxial cable is completely sheathed by a first insulation layer 5 of the coaxial cable. The first insulation layer 5 of the coaxial cable has a e which has a value of between 5 and 1. The first insulation layer 5 comprises a foamed material which has air chambers. The first layer 5 preferably comprises polytetrafluoroethylene, alternatively polypropylene or polyethylene. As an alternative, the first insulation layer 5 can also comprise only air. The first insulation layer 5 is, for its part, completely sheathed by a metallic layer 6 which serves as a sensor electrode. The sensor electrode builds up an electrical field. When the electrical field is influenced by a user by said user entering the detection area of the sensor unit, the vehicle controller is actuated by the sensor unit and initiates the process for opening the tailgate. In this exemplary embodiment, the metallic layer 6 is in the form of a metal foil and wire mesh, wherein, the wire mesh covers the metal foil. As an alternative, the metallic layer can also be in the form of only a wire which is helically wound and which sheaths the first layer 5. The metallic layer 6 is completely sheathed by a second insulation layer 7 which is formed from plastic and serves to provide insulation against external environmental influences in order to protect the metallic components of the coaxial cable against moisture and corrosion. The coaxial cable which is in the form of a sensor unit 3 is formed in a water-tight manner at one of its ends. The other end of the coaxial cable serves to receive a plug-type connection.

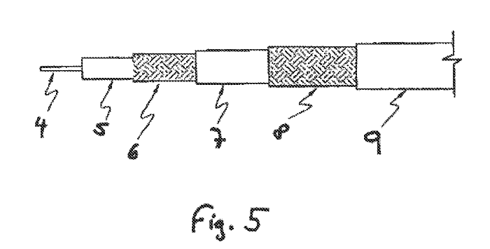

FIG. 5 illustrates, as a further exemplary embodiment, a coaxial cable which has a further metallic sheath, wherein this additional sheath is connected to ground, with the result that this sheath also serves as a shield for the sensor system with respect to the outside. The cable core has the same electrical potential as the first metallic sheath and therefore acts as an active shield toward the inside. The electrical sensor field toward the outside is intensified as a result.

In contrast, the second metallic sheath is intended to make the sensor inactive in those regions in which sensing is not necessary or incorrect sensing may occur.

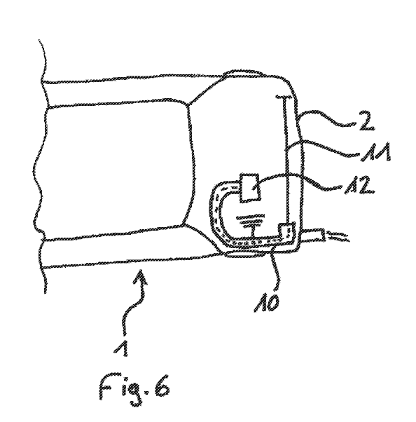

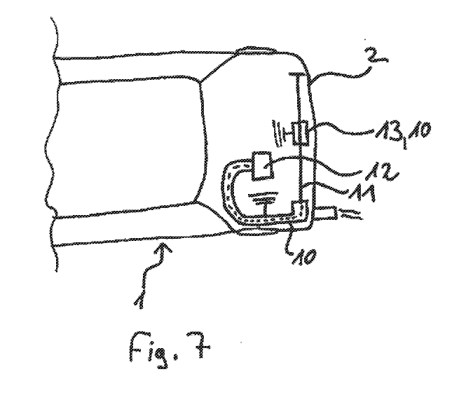

FIG. 6 is a schematic illustration of the entire system in a vehicle. The coaxial cable, in this case with a second metallic sheath, runs from a controller in the vehicle to the tailgate region, wherein the second metallic sheath is removed from the coaxial cable in the sensor zone, with the result that the sensor electrode (first metallic sheath) can be active.

The end regions of the coaxial cable are insulated in order to protect against environmental influences. The second metallic sheath is connected to ground (electrical, battery) and acts as a shield for the sensor.

FIG. 7 shows a further exemplary embodiment, wherein several sections of the coaxial cable do not have a second metallic sheath. The cable is divided into several sensing regions as a result. The intermediate section with the second metallic sheath can be connected to ground or not have an electrical connection.

The coaxial cable can have a plurality of intermediate sections with or without a second metallic sheath.

### LIST OF REFERENCE SYMBOLS

1 Vehicle
2 Bumper
3 Sensor unit
4 Conductor, core (+ potential), active shield
5 First insulation layer
6 First metallic layer, sheath, sensor electrode (+ potential)
7 Second insulation layer
8 Second metallic layer, sheath
9 Third insulation layer
10 Coaxial cable region with a second metallic sheath
11 Coaxial cable region without a second metallic sheath
12 Controller
13 Intermediate section with a second metallic sheath

1. An apparatus for operating a door or hatch of a vehicle, said apparatus comprising:
a sensor unit detecting an object in at least one detection area which borders the motor vehicle, with the result that the operation of the door or hatch can be activated using the detection, wherein the sensor unit includes a coaxial cable, wherein a conductor of the coaxial cable is in the form of a metallic core and serves as an active shield.

2. The apparatus as claimed in claim 1, in which the conductor of the coaxial cable is at least partially sheathed by a first insulation layer of the coaxial cable.

3. The apparatus as claimed in claim 2, in which the first insulation layer of the coaxial cable has a εᵣ which has a value of between 5 and 1.

4. The apparatus as claimed in claim 2, in which the first insulation layer is composed of a foamed material which has air chambers.

5. The apparatus as claimed in claim 2, in which the first insulation layer is composed of air.

6. The apparatus as claimed in claim 1, in which the first insulation layer is at least partially sheathed by a metallic layer which serves as a sensor electrode.

7. The apparatus as claimed in claim 6, in which the metallic layer is in the form of at least one of a metal foil, a wire mesh, and a wire.

8. The apparatus as claimed in claim 1, in which the metallic layer is at least partially sheathed by a second insulation layer.

9. The apparatus as claimed in claim 1, in which the core is in the form of a copper wire.

10. The apparatus as claimed in claim 1, in which the sensor device is arranged on a bumper.

11. The apparatus as claimed in claim 1, in which the coaxial cable which is in the form of a sensor unit is formed in a water-tight manner at at least one end.

12. The apparatus as claimed in claim 1, in which the coaxial cable is surrounded by an additional second metallic sheath.

13. The apparatus as claimed in claim 12, in which the second metallic sheath is connected to the ground.

14. The apparatus as claimed in claim 12, in which the coaxial cable is surrounded by an additional external insulation layer.

15. The apparatus as claimed in claim 12, in which the coaxial cable does not comprise a second metallic sheath in some regions, preferably in the end region, with the result that the coaxial cable acts as a sensor in these regions.

16. The apparatus as claimed in claim 15, in which the coaxial cable has a plurality of sections without a second metallic sheath.

17. The apparatus as claimed in claim 16, in which the metallic sheaths of the intermediate sections are connected to ground.

18. The apparatus as claimed in claim 7, in which said metallic layer is in the form of a helically wound wire

19. The apparatus as claimed in claim 8, in which said second insulation layer is composed of plastic which serves to provide insulation against external environmental influences in order to protect metallic components of the coaxial cable against moisture and corrosion.
